(19) United States
(12) Patent Application Publication
(10) Pub. No.: US 2004/0259641 A1
(43) Pub. Date: Dec. 23, 2004

(54) Method and system for enabling and managing a networking database and system supporting a multi-user network game

(76) Inventor: David YC Ho, Huntington Beach, CA (US)

Correspondence Address: GRAFFITI PROMOTIONS, LLC, 827 WINDSOR ROAD, ARNOLD, MD, 21012, US

(21) Appl. No.: 10/828,903

(22) Filed: Apr. 21, 2004

Related U.S. Application Data
(60) Provisional application No. 60/480,532, filed on Jun. 23, 2003.

(51) Int. Cl. G06F 17/00; G06F 19/00

(52) U.S. Cl. 463/42

(57) ABSTRACT

An interactive Internet-based reality game where participants, via an interactive website, create a publicly viewable profile in a server database that may contain such information as a photo of the participant and an accompanying paragraph of self-written text. The object of the game of the present invention is to get as many people as possible to look at the participant's profile thereby increasing his number of points. Points represent a scoring system related to the amount of public exposure a participant has received. The more people who view a participant's profile, the more exposure that participant will have and the more points he or she will accumulate. The result of playing this game is that the participant's image and thoughts can become widely known to a great number of other people.

### CROSS REFERENCE TO RELATED APPLICATIONS

This application claims priority from U.S. Provisional Patent Application Ser. No. 60/480,532 entitled GAME TO FAME-AN INTERNET GAME THAT HELPS PARTICIPANTS BECOME FAMOUS, filed Jun. 23, 2003.

### FEDERALLY SPONSORED RESEARCH

Not Applicable

### SEQUENCE LISTING OR PROGRAM

Not Applicable

### TECHNICAL FIELD OF THE INVENTION

The present invention relates generally to a networking database having a plurality of records corresponding to participants. The present invention relates more specifically to a game that enables participants via a computer network to create a profile and obtain a ranking based on the amount of public exposure and feedback they receive.

### BACKGROUND OF THE INVENTION

As demonstrated by the rise in reality television programming, many people today are increasingly intrigued with becoming famous or watching ordinary people compete in a game or event which exposes their personality, challenges their character and places them in adverse mental and physical conditions. There are several reality programs on television and many of the contestants have participated mainly to receive attention, become famous, or start an acting career.

With the increased usage of the Internet and an increasing percentage of high speed connections in households, many of these reality show participants have turned to the Internet to increase their exposure and fame either through such means as mass-emailing biographies, resumes, pictures or videos to others. Concurrently, many reality viewers are turning to the Internet to increase their knowledge about reality show participants by accessing a participant's personal website or a portion of the television network's website focused on the reality television show and having supporting content.

Additionally, online social networking, which allows users to provide data on themselves online with the goal of building a network for personal and professional use has gained popularity. Companies such as Friendster, Ryze, Linkedin, and Spoke have developed businesses based on the belief that people have a desire to develop a personal contact database to further their private or professional interests by networking through known individuals to obtain contact with a 3^{rd} party that can provide them with some benefit.

Many people are seeking fame or some type of recognition and there is a vast audience of individuals eager to provide the necessary judgment to separate and provide distinction to those fame seekers by providing feedback such as an individual ranking on a scale, comparison rankings, or through a system that can receive or grade comments from another party based on certain characteristics of the fame seeker such as beauty or musical talent. The present invention joins fame seekers and those willing to provide judgment using the Internet as a meeting place that provides a platform for the fame seekers to describe themselves and a means for those wishing to make a judgment to be heard.

The present invention has combined the rise in popularity of reality-based television programming with the social networking approach to provide a reality-based game whose methodology is similar to the social networking approach many companies have taken. Thus, the present invention can embody several forms ranging from a simple, one person broadcasting point for an individual displaying a profile, to a complete social network of people competing for fame.

### SUMMARY OF THE INVENTION

The present invention generally relates to a computer networking game anyone can play. The game is played on a multi-user electronic network (such as the Internet or World Wide Web) and uses a web browser or any other thin client program or device specifically created to interact with the game's software servers.

Participants create, via an interactive website, a publicly-viewable profile of themselves in a server database that may contain such information as a photo of the participant and an accompanying paragraph of self-written text. The object of the game of the present invention is to get as many people as possible to look at the participant's profile thereby increasing his number of points. Points represent a scoring system related to the amount of public exposure a participant has received. The more people who view a participant's profile, the more exposure that participant's will have and the more points he or she will accumulate. In addition, a participant can receive points by inviting other people to join the game. The result of playing this game is that the participant's image and thoughts can become widely known to a great number of other people.

### BRIEF DESCRIPTION OF THE DRAWINGS

FIG. 1A is a block diagram that depicts the basic hardware and software architecture required to support the game methodology and play of the present invention;

FIG. 1B is a block diagram that depicts the elements of a participant profile used in the game;

FIG. 2 is a diagram depicting the basic rules criteria necessary to play the game of the present invention;

FIG. 3 is a flow chart illustrating the process of a participant registering to play the game of the present invention;

FIG. 4 is a flow chart illustrating the process of a participant obtaining points from a random viewer of said participant's profile;

FIG. 5A is a flow chart illustrating the process of a participant emailing their respective profile to a third party for review and the process for obtaining points from a referred viewer;

FIG. 5B is a flow chart illustrating the email code validation process of the present invention;

FIG. 6 is a flow chart illustrating the process of a participant inviting a third party to become a new participant in the game, with the inviting participant receiving points for the successful registration of the invited third party.

FIG. 7 illustrates the social networking component of the game methodology of the present invention;

FIG. 8 illustrates a typical participant profile as viewed through a web browser.

### DETAILED DESCRIPTION OF THE INVENTION

In the following detailed description of the invention and exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known networking and database structures and techniques known to one of ordinary skill in the art have not been shown in detail in order not to obscure the invention.

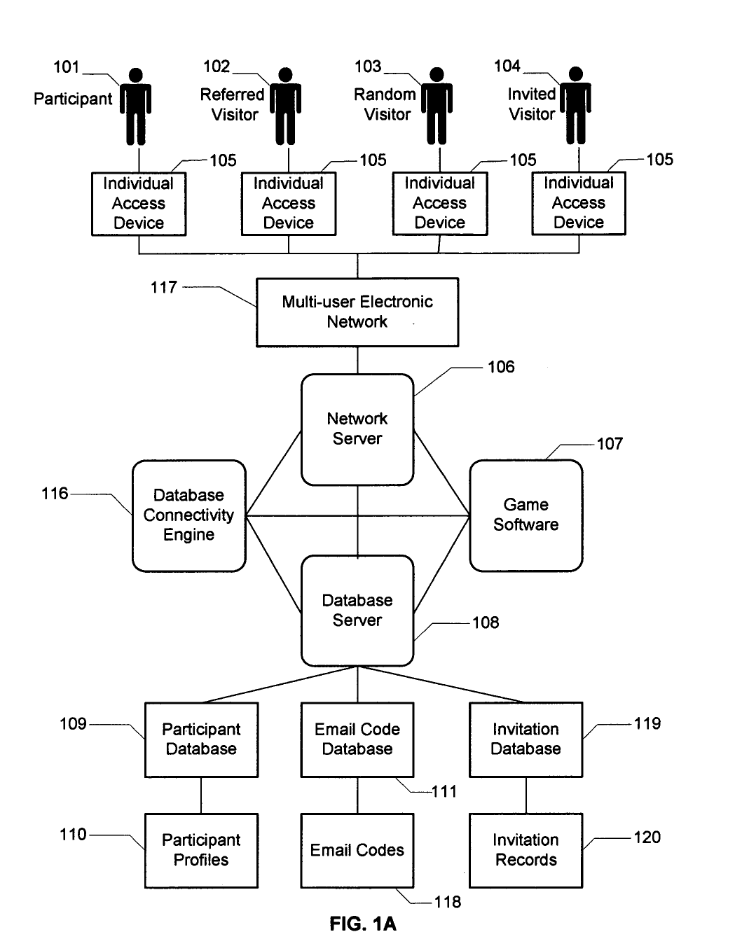

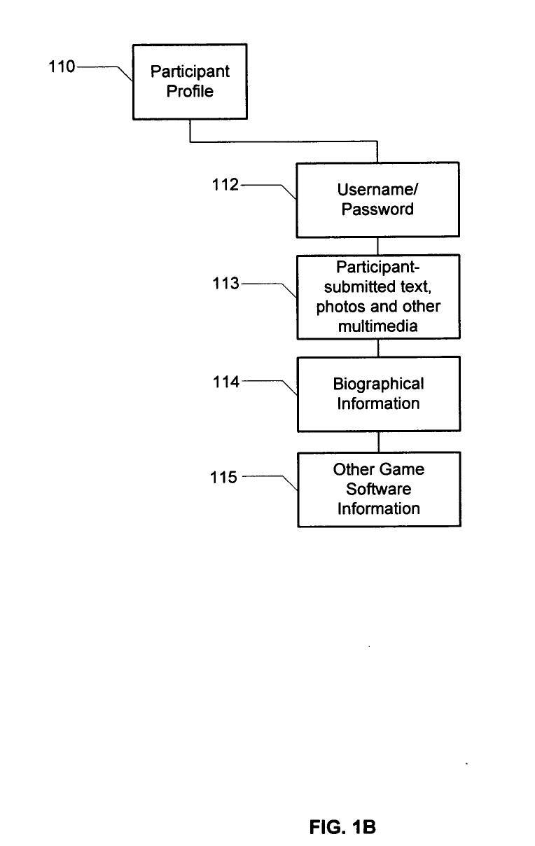

FIG. 1A illustrates the basic hardware and software architecture required to support the game methodology and play of the present invention. The game of the present invention is played on a multi-user electronic network (117) (such as the Internet or World Wide Web) and utilizes well-known networking and database programming that is well known to one of ordinary skill in the art. Any user, such as a participant (101), referred visitor (102), random visitor (103), or invited visitor (104) may access the network server (106) utilizing any number of access devices (105). Access devices may include, but are not limited to, such electronic devices as a cell phone, personal data assistant (PDA), network computer, home computer, terminal based computer, portable computer, or any other electronic device that is enabled to connect to a network and retrieve data. The network server (106) enables any user to access the data contained within the network server using a web browser or any other thin client program or device specifically created to interact with the game's network server.

The network server (106) contains the game software (107) used to generate the necessary databases for the game to function, compute point totals, manage internal and external communications, and provide external viewing screens as necessary to users.

“Game software” (107) is defined as the software code written for a network server (106), which will implement the game rules and software architecture so that the game may be played in a multi-user networked environment accessible through a variety of access devices (105).

The game software (107), through a database server (108), will handle such things as new participant account creation, retrieval of forgotten passwords, and modification of participant account information by creating a participant database (109) containing participant profiles (110). As shown in FIG. 1B, a participant profile (110) is a database record that contains a participant's (101) profile information. This profile information includes, but is not limited to, a username and password (112); participant submitted materials for display in a profile such as text, photos and other multimedia (113); biographical information (114) such as name, age, sex, and email address; and game software information (115) such as profile creation date, points, participant profile valid flag, and database record ID number. Other fields in the participant profile (110) may be added later such as, but not limited to, participant-submitted multimedia, geographic location, guest book entries, payment and financial information, etc.

FIG. 1A also shows a database connectivity engine (116) that is controlled by the game software (107) and connected to the network server (106) and database server (108). The database connectivity engine (116) is used to retrieve participant profiles (110) stored on the database server (108) for use by the network server (106) in displaying participant profile (110) information on a user's access device (105) that is connected to the multi-user network (117). The database connectivity engine (116) also allows for processing information stored in the participant database (109), receiving input from the network server (106) to enable the receipt of a participant's profile (110), and recording of points and other game software information (115). The database server (108) also manages the email codes (118) that are stored in the email code database (111), and the invitation records (120) stored in the invitation database (119).

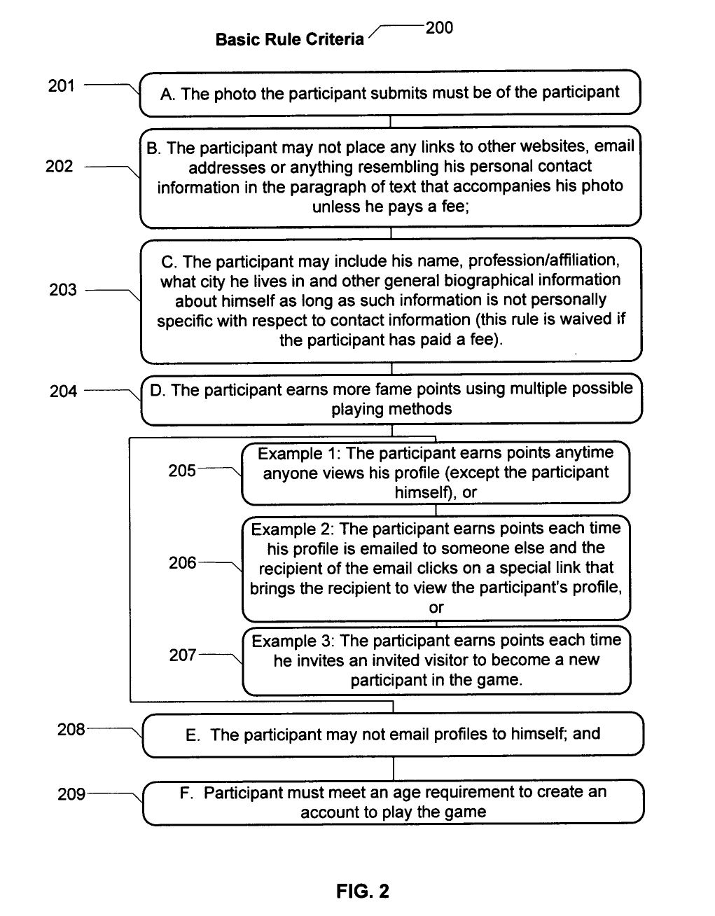

In FIG. 2 the rules criteria (200) for the game play methodology of the present invention include the following rules:

(A) In rule A (201) any photo the participant (101) submits, which the participant claims is a photo of the participant (101), must indeed be a photo of the participant (101) himself;

(B) In rule B (202) the participant (101) may not place any links to other websites, email addresses or anything resembling his personal contact information in the paragraph of text that accompanies his photo unless he pays a fee;

(C) In rule C (203) the participant (101) may include his name, profession/affiliation, what city he lives in and other general biographical info about himself as long as such information is not personally-specific with respect to contact information (this rule is waived if the participant (101) has paid a fee);

(D) In rule D (204) the participant (101) earns more fame points using multiple possible playing methods as illustrated in the following examples. In example 1 (205) the participant (101) earns +1 point anytime anyone views his profile (except the participant (101) himself). In example 2 (206) the participant (101) can earn +25 points each time his profile is emailed to someone else and the recipient of the email clicks on a special link that brings the recipient to view the participant's (101) participant profile (110). In example 3 (207) the participant (101) earns +100 points each time he invites an invited visitor (104) to become a new participant (101) in the game. One of ordinary skill in the art will appreciate that other playing methods and any combination of multiple playing methods can be incorporated to allow participants the ability to earn points.

(E) In rule E (208) the participant (101) may not email profiles to himself; and

(F) In rule F (209), the participant (101) must meet age requirements to create an account and play the game. Typically the minimum age to participate would be 18.

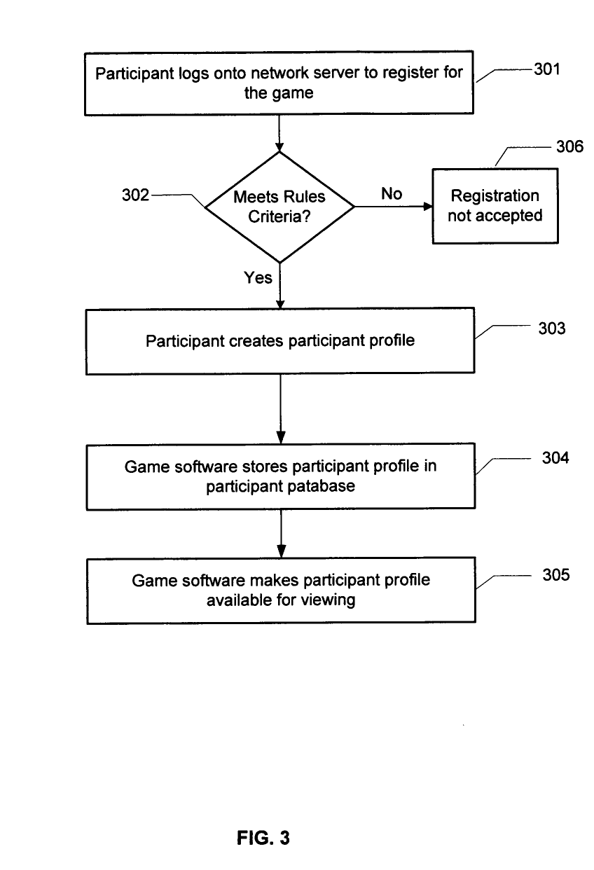

Now referring to FIG. 3, in the most basic embodiment of the game of the present invention, in step 301 a participant (101) uses his access device (105) to log onto the network server (106) to register for the game. In step 302, the participant (101) is queried by the game software (107) to ascertain whether the participant (101) meets the rules criteria (200). If the participant (101) does not meet the rules criteria (200), then in step 306 the game software (107) informs the participant (101) that their registration was not accepted. If the participant (101) meets the rules criteria (200), then in step 303, the game software (107) allows the participant (101) to create a participant profile (110). Once step 303 is complete, step 304 occurs where the game software (107) stores the participant profile (110) into the participant database (109). Now step 305 occurs, where the game software (107) makes the new participant profile (110) available for viewing on the multi-user electronic network (117).

The object of the game of the present invention is to get as many participants (101), referred visitors (102) and random visitors (103) to view a participant's profile (110) over a multi-user electronic network (117), and to invite invited visitors (104) to become participants (101) in the game. All these actions would increase the number of points in the game for said participant (101). Points for a participant (101) represent a scoring system related to the amount of public exposure a participant (101) has received. The more people who view a participant's (101) participant profile (110), the more exposure that participant (101) will have and the more points he or she will accumulate. In addition, the more invited visitors (104) that participant (101) invites to join the game, the more points the participant (101) will gain. The result of playing this game is that a participant's (101) image and thoughts can become widely known to a great number of other people.

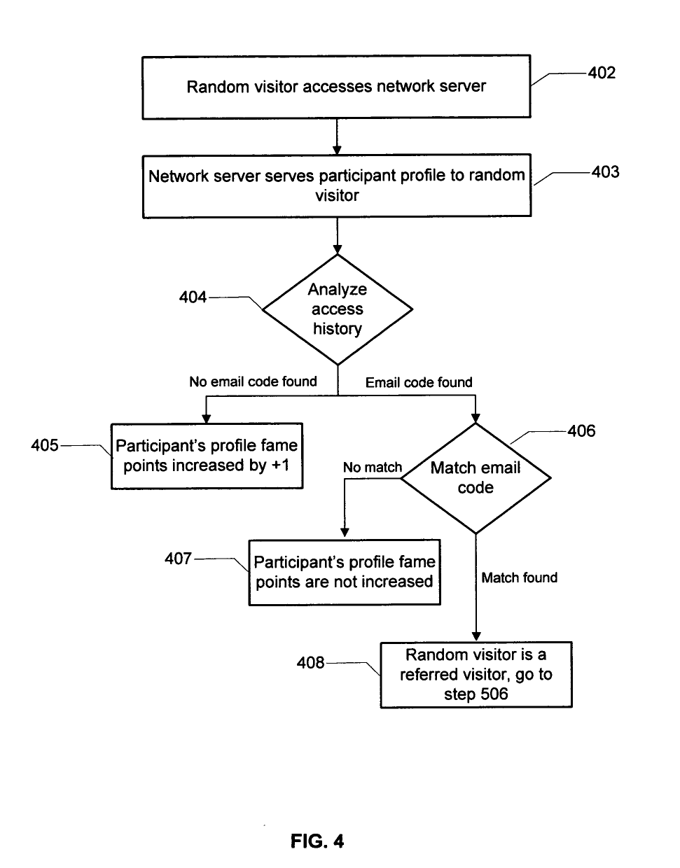

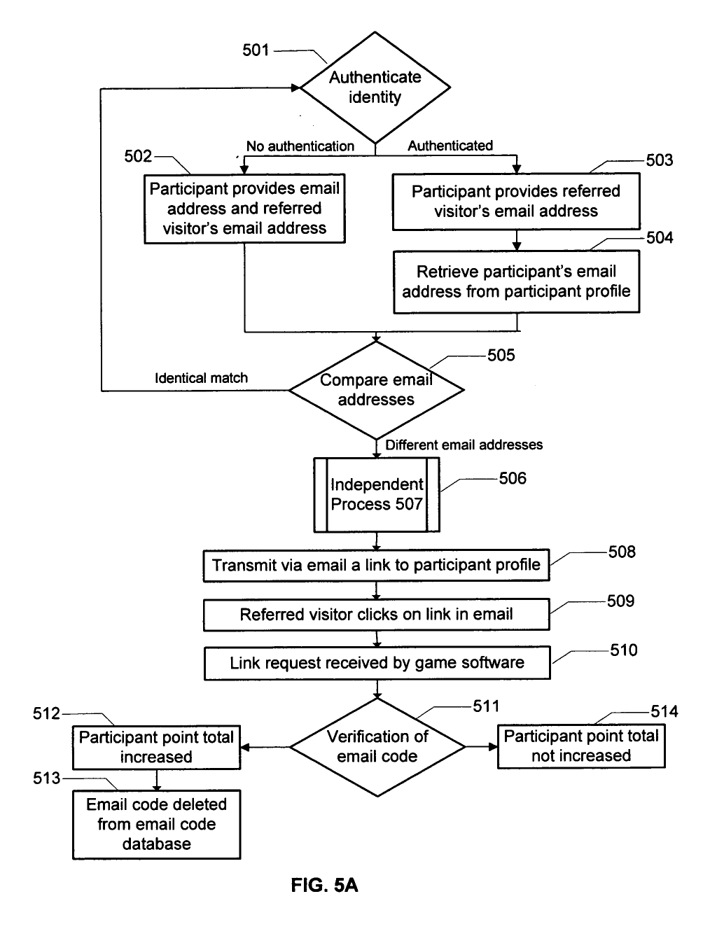

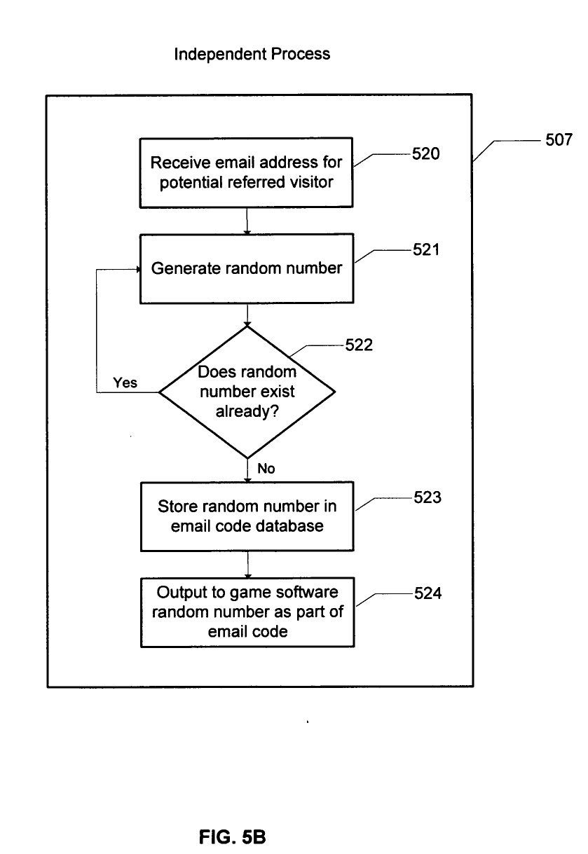

FIG. 4 shows a flowchart of how a participant (101) obtains points from a random visitor (103) to said participant's (101) participant profile (110). In step 402 a random visitor (103) on a multi-user electronic network (117) accesses the network server (106). In step 403, the network server (106) serves a participant profile (110) to the random visitor (103) on the random visitor's (103) access device (105). In step 404 the game software (107) will analyze the random visitor's (103) access history to determine how the random visitor (103) linked to the network server (106). If, in step 404, the game software (107) does not find an email code (118) submission in the random visitor's (103) access history, then step 405 occurs and the game software (107) increases the participant's (101) point total by a predetermined amount, which in this embodiment is one point. If however, in step 404 the game software (107) finds an email code (118) in the random visitor's (103) access history, then step 406 occurs where the game software (107) determines whether the email code (118) is present in the email code database (111). If the email code (118) is not found in the email code database (111) then the game software (107) reaches step 407 and the participant's (101) point total is not increased by the game software (107). If however, in step 406, the email code (118) is determined to match an email code (118) record in the email code database (111), then step 408 occurs, and the random visitor (103) is identified as a referred visitor (102) and the game software (107) advances to step 506 in FIG. 5.

FIG. 5A describes one embodiment for how a participant (101) may provide their participant profile (110) to a referred visitor (102) in an attempt to gain additional points. In step 501 the game software (107) determines if the participant (101) has authenticated their identity to the game software (107). If the participant (101) has not authenticated their identity, step 502 occurs and the game software (107) will ask the participant (101) to provide the game software (107) with both the participant's (101) email address and the potential referred visitor's (102) email address. If, however, the participant (101) has authenticated their identity to the game software (107), step 503 occurs and the game software (107) will only require the participant (101) to provide the potential referred visitor's (102) email address. After step 503, the game software (107) will proceed to step 504 and retrieve the participant's (101) email address from the participant's (101) stored participant profile (110).

The next step after both steps 502 and 504 is step 505, where the game software (107) compares the email address of the referred visitor (102) to the participant's (101) email address. If the email addresses are the same, the game software (107) returns an error message and goes back to step 501. If the email addresses are different, the game software (107) proceeds to step 506, where the game software (107) then generates an email code (118) using an independent process (507) described below. In step 508, the game software (107) transmits to referred visitor (102) through the multi-user electronic network (117) an email containing a link to the participant profile (110), which link also contains an email code (118). In step 509, a referred visitor (102) receives the email from the game software (107) and clicks on the link to the participant's profile (110), which in turn generates a link request to the game software (107).

In step 510 the game software (107) receives referred visitor's (102) link request through the multi-user electronic network (117). In step 511 the game software (107) verifies whether the referred visitor's (102) link request contains an email code (118) that was previously stored in the email code database (111) during a prior session of the independent process (507). If the verification process that occurs in step 511 confirms that the link request contains an email code (118) that was previously stored in the email code database (111), then step 512 occurs and the participant's (101) point total is increased by a predetermined amount, which in the preferred embodiment is 25 points. After step 512 has occurred, step 513 occurs where the game software (107) deletes the email code (118) from the email code database (111). If however, the verification process that occurs in step 511 cannot match the email code (118) in the link request with an existing email code entry in the email code database (111), then step 514 occurs and the participant (101) receives no fame points.

The independent process (507) is illustrated by FIG. 5B. In step 520, the game software (107) receives an email address for a potential referred visitor (102). In step 521, the game software (107) generates a random number between 1 and 9999999. In step 522 the game software (107) verifies whether this newly generated random number already appears in the email code database (111). If the answer is yes, then the game software (107) repeats step 521. If the answer is no, meaning that the newly generated random number is unique and does not already appear in the email code database (111), then step 523 occurs and the newly generated random number is stored in the email code database (111). Then step 524 occurs and the game software (107) returns as the end of independent process (507) an email code (118) that contains the newly generated random number, which email code (118) is then appended by the game software (107) to a link containing the participant profile (110) of the participant (101) that is trying to contact the referred visitor (102).

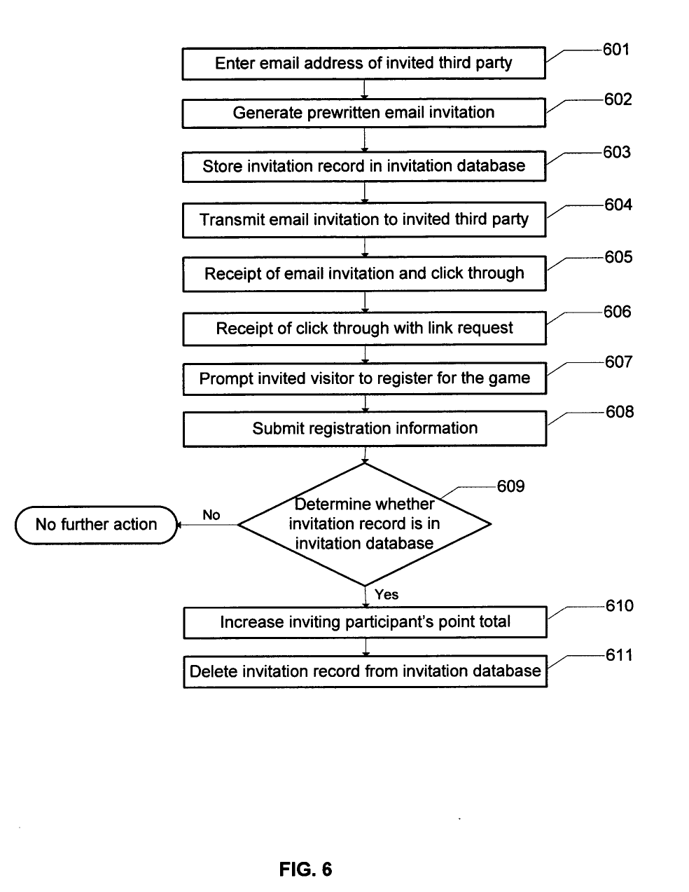

FIG. 6 shows how a participant (101) can invite a third party to become an invited visitor (104). In step 601, a participant (101), who has already been authenticated by the game software (107), uses their access device (105) to enter in the email address of a third party that the participant (101) wants to invite to join the game. In step 602, the game software (107) takes this email address and generates a pre-written email message inviting the invited visitor (104) to join the game. In step 603, the game software (107) then stores in the invitation database (119) a unique invitation record (120) that contains the inviting participant's (101) user ID, the invited visitor's (104) email address, and a time and date stamp. In step 604, the game software (107) then electronically transmits to the invited visitor (104) the pre-written email message, which includes an embedded reference to the unique invitation record (120) generated in step 603.

In step 605, the invited visitor (104) receives the email from the game software (107) and clicks through the link within the email, which generates a link request to the game software (107). In step 606 the game software (107) receives the invited visitor's (104) link request through the multi-user electronic network (117). In step 607 the game software (107) prompts the invited visitor (104) to register to become a new participant (101) in the game (see FIG. 3). In step 608, the invited visitor (104) submits their registration information (which includes the embedded reference to the unique invitation record (120) generated in Step 603) to the game software (107). In step 609, the game software (107) determines whether or not the unique invitation record (120) appears in the invitation database (119). If the invitation record (120) appears in the invitation database (119), then step 610 occurs where the game software (107) increases the inviting participant's (101) point total by a predetermined amount, which in the preferred embodiment is 100 points. After step 610, step 611 occurs where the game software (107) deletes the unique invitation record (120) from the invitation database (119). If, in step 609, the game software (107) determines that the unique invitation record (120) does not appear in the invitation database (119), then the game software (107) takes no further action.

One of ordinary skill in the art will appreciate that the flowchart and processes outlined in FIGS. 5A, 5B and 6 can be adapted and applied to use other electronic transmission methods over a multi-user electronic network (117) in addition to email. Other electronic transmissions that can be accommodated by the game software (107) would include, but not be limited to, text messaging via phones, PDAs, or other multi-user network based system such as AOL Instant Messenger or Microsoft Instant Messenger.

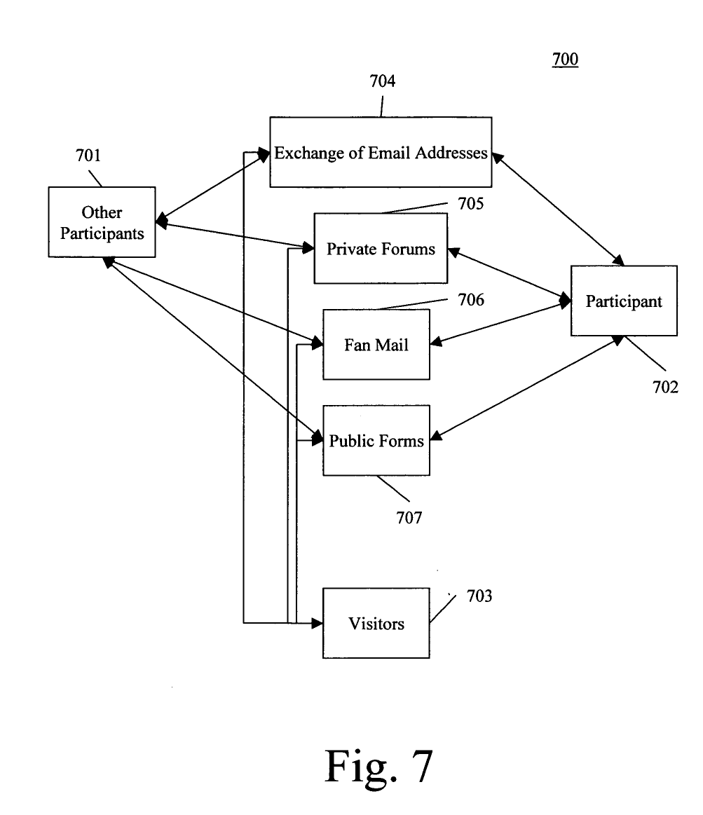

Now referring to FIG. 7 the social networking structure (700) of the present invention is described. The three main groups of users accessing, utilizing, and communicating through the network server (106) and game software (107) of the present invention are the group of participants as a whole (701), visitors (whether invited, referred or random) (703), and a single participant (702). The game software of the present invention provides four main means for enabling communication and networking between the three groups. The groups may use individually or in combination the exchange of emails in any text communications handled by the game software (107), including email (704), private forums (705), fan mail (706), and public forums (707). For example a single participant (702) may use fan mail (706) to communicate with a specific participant in the participant group (701). Also, a single participant (702) may list in their participant profile (110) that the participant (702) is friends with a small group of other participants in the participant group (701) so that visitors (703) may consider viewing those friends' participant profiles (110) as well.

One of ordinary skill in the art appreciate that in other embodiments of the game of the present invention link and email address can be made readily available to viewers and be included in the a participant's (101) participant profile (110). It should be appreciated that the fee-based portion of the present invention is currently focused on generating revenue by requiring participants (101) to pay a fee for submitting additional contact information in their participant profile (110), but this is subject to change in such a manner that such inclusions become free or required. In addition, other fee services would allow enhanced or additional information to be included in the participant profile (110) such as audio, video, streaming file capability, or other multi-media functionality.

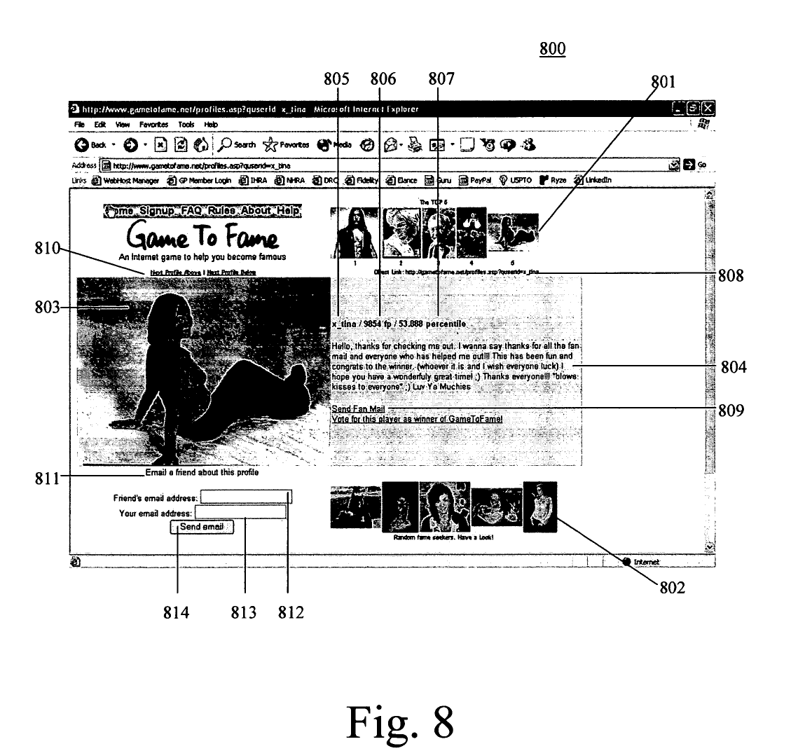

Now referring to FIG. 8, in one embodiment of the website representation of the game (800) of the present invention, the five participants (101) with the highest number of fame points will be queried from the participant database (109) and have their thumbnailed images displayed on every page of the site (801). The full-size photo (803) of the participant (101) with the highest number of fame points will be displayed on the home page. Five randomly selected participant profiles (110) will be queried from the participant database (109) and have their thumbnailed images displayed every time a user of the site is viewing a participant profile (802).

Users (whether participants or otherwise) will be able to view participant profiles (110) by one of four methods: (1) randomly selecting a participant profile (110); (2) clicking on the thumbnail of a displayed participant's (101) photo; (3) clicking on the “next profile above” or “next profile below” links (810); or (4) by directly linking to a participant profile (110) that the user is interested in viewing.

For each participant profile (110) displayed on the website of the game of the present invention, the following information will be displayed along with the participant-submitted photo (803) and participant-written text (804): (1) the participant's username (805), (2) the total accumulated fame points (806), (3) the ranking of the participant profile based on fame points (807), and (4) a text string (808), containing the direct link information for that specific participant profile (110). For each participant profile (110) displayed, a link to view the next highest ranked profile or the next lowest ranked profile based on fame points will be made available (810).

For each participant profile (110) created, the participant (101) will have the option of adding a public guest book that is simply a publicly viewable log where viewers may leave public comments to the participant. The participant (101) has a fan mail (809) function, which can be thought of simply as a private guest book. The private guest book enables viewers to leave private messages or comments for the participant (101) to read which may be anonymous if the guest so elects. Additionally, a participant (101) has the ability to block fan mail coming from a specific, registered game participant or from anonymous viewers.

A user (whether a participant (101) or otherwise) may elect to email a friend (811) about the participant profile (110) currently being displayed by entering their friend's email address (812), their own email address (813), and sending the email via the game software (107) and networking server (106) by selecting the “send email” button (814).

The game software (107) may compile and display participant profiles (110) within several tiers of fame based on such criteria as geography (e.g. Northeast United States, Northwest United States, etc.), city, county, state, province, etc.

In another embodiment of the invention there is an “adaptive” anti-cheat mechanism built into the game so that participants (101) cannot gain points without following the rules of the game. The anti-cheating mechanism is is adaptive in that it changes from time to time so that the participants cannot easily figure out how it works through simple trial-and-error.

In another embodiment of the invention, a site-wide message board may be implemented. This is simply a forum where only game administrative staff and registered participants may post publicly-viewable messages.

In another embodiment of the invention, keyword and location searches may be implemented to enable guests and participants to only view participant profiles (110) based on a specific geographical location or group represented by a keyword. In a participant profile (110), a participant (101) can fill in keywords, state of residence, zip code and other location specific information about themselves. Other guests and participants will be able to view only participant profiles (110) based on keyword or location criteria enabling the game to be played or viewed in a global, or regional mode setting.

In yet another embodiment of the invention multi-media content is incorporated in the participant profile (110). This feature allows participants (101) to add multiple photos, audio, video, flash, etc. to their participant profiles (110). With the increasing number of households that are moving from dial-up Internet connections to broadband systems such as DSL and cable, one of ordinary skill in the art can appreciate that with the increased connection speed of users in their homes, the current limitations of file size and multi-media files will be removed. Once this barrier is sufficiently removed, the participant profiles (110) can be expanded to include other multi-media files that will not hinder a participant (101) or guest's enjoyment or ability to participate in the game.

In yet another embodiment of the invention a participant (101) may create a friend network that allows a participant (101) to list in his profile the names of other participants who are friends, thus creating a friend network. This functionality is well known in the prior art and is well documented in the market place by online dating services, MSN Messenger, and Friendster.

Therefore, the foregoing is considered as illustrative only of the principles of the present invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention. Thus, the scope of the invention should be determined by the appended claims and their legal equivalents, rather than by the examples given.

The embodiments of the invention in which an exclusive property or privilege is claimed are defined as follows:

1. A method for playing a multi-user network game comprising the steps of;
providing a multi-user network having a network server connected to an electronic network with game software for implementing the game rules on said network server for running the game play and enabling access by users, a database server connected to said network server for storing and generating information as required by said game software;
one or more participants each using said game software to store participant profile information in said database server for viewing by any user;
each of said participants following instructions located in the game rules software, said participants following instructions from said game software on how to utilize their respective stored profiles in said database server to gain exposure to other users;
scoring said participants according to said game software rules.

2. A method for playing a game as defined in claim 1 wherein a participant according to said game software rules may earn points any time anyone views said participant's profile except the participant himself.

3. A method for playing a game as defined in claim 1 wherein a participant according to said game software rules may earn points each time his profile is submitted via an electronic transmission to someone else and the recipient of the electronic transmission clicks on a special link in said transmission that brings the recipient to view said emailing participant's profile.

4. A method for playing a game as defined in claim 1 wherein a participant according to said game software rules may earn points each time an invited visitor receives an electronic invitation to join the game and said invited visitor of the electronic transmission clicks on a special link in said transmission that brings the recipient to view the game and results in said visitor registering as a new participant.

5. A method for playing a game as defined in claims 3 and 4 wherein the electronic transmission takes the form of an email message or a text message.

6. A method for playing a game as defined in claims 4 and 5 wherein the use of electronic messaging as an integral component of the game play, defined by said game software, in order for a participant to accumulate points, is not used only for communication, but as the primary method of competing with other participants to accumulate points.

7. A method for playing a game as defined in claim 1 wherein a participant may according to said game software rules earn points in three ways;
the first being anytime anyone views said participant's profile except the participant himself;
the second being each time his profile is submitted via an electronic transmission to someone else and the recipient of said electronic transmission clicks on a special link that brings the recipient to view the profile of the participant initiating said electronic transmission;
the third being each time an invited visitor receives an electronic invitation to join the game from said participant and said invited visitor of the electronic transmission clicks on a special link in said transmission that brings the recipient to view the game and results in said visitor registering as a new participant.

8. A method for playing a game as defined in claim 2 wherein the game software incorporates an electronic transmission verification process wherein;
validation codes are generated for said database server when a participant or guest submits an electronic transmission of a profile to someone else from said network server;
the game software processes said electronic transmission and generates a random number validation code that is stored in a separate database within the database server and is sent within the body of said electronic transmission to the recipient;
said electronic transmission contains a link back to the profile and will pass the validation code to the game software server when the recipient receives the electronic transmission and clicks the link to visit the profile; the game software will accept this validation code and search the database table of all validation codes for a match;
if a match is found, the profile linked to in the body of the electronic transmission will receive a second amount of predetermined points, the matching code is then removed from the validation code database table;
if no match is found, the code is not validated and the viewed profile receives no points.

9. A method for playing a game as defined in claims 1, 2, 3, 4, 5, 6, 7 and 8 which provides participants a way to promote themselves among other participants and other non-participants to gain exposure, publicity and possible fame.

10. A method for playing a game as defined in claims 1, 2, 3, 4, 5, 6, 7 and 8 in which any participant may according to said game software rules earn points anytime someone else, whether participant or random viewer, is brought into the game to take some action for the participant's benefit as determined by said game software.

11. A method for playing a game as defined in claims 1, 2, 3, 4, 5, 6, 7 and 8 wherein a participant gains points in any manner defined by said game software.

12. A multi-user electronic network game comprising;
a network server connected to a multi-user electronic network;
a database server connected to said network server for running on the network server;
a database connectivity engine connected to the network server for processing the output of the network server;
said database connectivity engine connected to the database server for processing the output of the database server and input received from the network server;
game software that implements the game rules on said network server for running the game play;
a plurality of participants each accessing the game server and said game software to create participant profiles;
one or more participants registered to play the game;
a publicly viewable profile created by one or more participants stored on said database server for viewing on the multi-user network;
each of said participants following instructions located in the game rules software, said participants following instructions from said game software on how to utilize their respective stored profiles in said database to gain exposure;
scoring said participants according to said game software rules.

13. A multi-user electronic network game of claim 12 wherein said game software rules require for participant registration that:
the photo participant submitted by the participant is of the participant himself;
the participant has not placed any links to other websites, email addresses or anything resembling his personal contact information in the paragraph of text that accompanies his photo unless he pays a fee;
the participant may include biographical information such as his name, profession/affiliation, what city he lives in and other such general information;
the participant earns points using at least one playing method as said forth by the game software;
the participant may not email profiles to himself;
the participant must meet any other requirements as set forth by the game software.

14. A multi-user electronic network game as defined in claim 12 wherein said profile includes such information as a photo of the participant and an accompanying paragraph self-written text.

15. A multi-user electronic network game as defined in claim 13 wherein said network server includes a server to process incoming and out going electronic transmissions connected to the database server; said database server includes a second database used to generate random numbers to server as validation codes.

16. A multi-user electronic network game as defined in claim 14 wherein a participant may, according to said game software rules, earn points each time his profile is emailed to someone else and the recipient of the email clicks on a special link that brings the recipient to view the participant's profile.

17. A multi-user electronic network game as defined in claim 15 wherein the game play methodology further includes an electronic transmission verification process wherein;
said validation codes are generated when a participant or guest send, via electronic transmission, a profile to someone else from said network server;
the game software, processes the electronic transmission and generates a random number validation code which is stored in a third database and sent within the body of the electronic transmission to the recipient;
said electronic transmission contains a link back to the profile and will pass the validation code to the game software server when the recipient receives the electronic transmission and clicks the link to visit the profile; the game software will accept this validation code and search the database table of all validation codes for a match;
if a match is found, the profile linked to in the body of the electronic transmission will receive points, the matching code is then removed from the validation code database table, but if no match is found, the code is not validated and the profile receives no points.

18. A method for playing a game as defined in claims 12, 13, 14, 15 and 16 wherein a participant may, according to said game software rules, earn points in three ways;
the first being anytime anyone views said participants profile except the participant himself;
the second being each time his profile is submitted via an electronic transmission to someone else and the recipient of said electronic transmission clicks on a special link that brings the recipient to view the profile of the participant initiating said electronic transmission; or
the third being each time an invited visitor receives an electronic invitation to join the game from said participant and said invited visitor of the electronic transmission clicks on a special link in said transmission that brings the recipient to view the game and results in said visitor registering as a new participant.

19. A system and method for playing a multi-user network game comprising;
a network server connected to a multi-user electronic network;
a database server connected to said network server for running on the network server;
a database connectivity engine connected to the network server for processing the output of the network server;
said database connectivity engine connected to the database server for processing the output of the database and input received from the webserver;
game software that implements the game rules on said network server for running the game play;
one or more participants registered to play the game;
the game software requiring that;
the photo participant submitted by the participant is of the participant himself;
the participant has not placed any links to other websites, email addresses or anything resembling his personal contact information in the paragraph of text that accompanies his photo unless he pays a fee;
the participant may include biographical information such as his name, profession/affiliation, what city he lives in and other such general information;
the participant earns points using at least one playing method as said forth by the game software;
the participant may not send profiles via electronic transmission to himself;
the participant must meet any other requirements as set forth by the game software.
one or more participants each accessing the game server and said game software to create participant profiles;
one or more participants each using said game software to store a participant portfolio in said database server for viewing by any network user;
a publicly viewable profile created by one or more participants stored on said database server for viewing on the multi-user network;
said participant profiles may include such information as a photo of the participant and an accompanying paragraph of self-written text;
each of said participant's following instructions located in the game rules software, said participants following instructions from said game software on how to utilize their respective stored profiles in said database to gain exposure;
scoring said participants according to said game software rules;
each of said participants following instructions located in the game rules software, said participants following instructions from said game software on how to utilize their respective stored profiles in said database to gain exposure;
scoring said participants according to said participants ability and/or usage of game software to attract viewers to their profile according to said game software rules;
validation codes are generated for said database server when a participant or guest send, via electronic transmission, a profile to someone else from said network server;
the game software processes the electronic transmission and generates a random number validation code that is stored in a separate database within the database server and is sent within the body of the electronic transmission to the recipient;
said electronic transmission contains a link back to the profile and will pass the validation code to the game software server when the recipient receives the electronic transmission and clicks the link to visit the profile; the game software will accept this validation code and search the database table of all validation codes for a match;
if a match is found, the profile linked to in the body of the electronic transmission will award points and the matching code is then removed from the validation code database table;
if no match is found, the code is not validated and the viewed profile receives no points.

19. A system and method for playing a multi-user network game of claim 18 wherein a participant may, according to said game software rules, earn points in three ways;
the first being anytime anyone views said participants profile except the participant himself;
the second being each time his profile is submitted via an electronic transmission to someone else and the recipient of said electronic transmission clicks on a special link that brings the recipient to view the profile of the participant initiating said electronic transmission; or
the third being each time an invited visitor receives an electronic invitation to join the game from said participant and said invited visitor of the electronic transmission clicks on a special link in said transmission that brings the recipient to view the game and results in said visitor registering as a new participant.

20. A system and method for playing a multi-user network game of claim 18 wherein a participant earns points in any manner defined by said game software.
